(19) United States
(12) Patent Application Publication
(10) Pub. No.: US 2006/0130643 A1
(43) Pub. Date: Jun. 22, 2006

(54) Hydraulic actuator with internal channels and quick connections

(76) Inventor: Lucas Frank, Farmington, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/021,155

(22) Filed: Dec. 22, 2004

(51) Int. Cl. F15B 11/08

(52) U.S. Cl. 91/432

(57) ABSTRACT

An extendable and retractable hydraulic actuator has a housing that defines an internal bore within which a piston and rod are arranged to move longitudinally. According to the hydraulic pressure on either side of the piston, the piston is forced back and forth in the bore causing the end of the actuator to either extend or retract. The bore has dual inlet and outlet ports, normally at one end of the actuator, such that one inlet port causes fluid to enter and force the rod in one direction while fluid from the other port flows to an opposite end of the actuator through channels within the housing and enters the bore on the opposite side of the piston forcing the piston to move in the opposite direction. A swing plate that pivots about one of the quick connection fittings secures the fittings to the housing.

### FIELD OF THE INVENTION

The present invention relates to hydraulic cylinders. More specifically, the present invention relates to a hydraulic actuator having an internal channeling system and a quick connection mechanism.

### BACKGROUND OF THE INVENTION

Hydraulic actuators actively engage the stabilizer bar during cornering maneuvers to limit vehicle sway or hydraulically disengage from the stabilizer bar to permit further articulation of the suspension to enhance off-road performance. While current hydraulic actuators have generally proven to be satisfactory for their applications, each is associated with its share of limitations. One major limitation with many current hydraulic actuators relates to the location of the hydraulic lines that are used to supply hydraulic fluid to the hydraulic actuator. Because the location of most hydraulic actuators is generally within or around the suspension and steering components of a vehicle, the hydraulic lines supplying hydraulic fluid to the hydraulic actuators normally must bend in order to supply the top of the actuator and the bottom of the actuator. This bending of the lines utilizes space under the vehicle that could be used for another purpose. Finally, the bending of the lines may induce stress into the lines.

What is needed is a device that does not suffer from the above limitations. This, in turn, will provide a device that eliminates the need to use bent hydraulic fluid lines proximate to the hydraulic actuator before being coupled to the hydraulic actuator. Furthermore, a device will be provided to increase the stroke of the piston and associated rod of a hydraulic actuator. Finally, a device will be provided that uses fewer parts in the connection of the fluid lines and requires less time to make such connection. Therefore, the teachings of the present invention provide a hydraulic actuator that achieves the above-identified advantages.

### SUMMARY OF THE INVENTION

In accordance with the teachings of the present invention, a hydraulic actuator for providing rotation to a vehicle stabilizer bar is disclosed. A hydraulic actuator has a housing defining an internal cavity within which a piston and rod are arranged to move longitudinally within the internal cavity. The hydraulic actuator has at least a first port disposed in the actuator for delivering fluid from one of a rod side or a non-rod side of the piston to an opposite side of the piston to an end of the internal cavity via an internal channel parallel to said internal cavity. The actuator may have a second port disposed adjacent to the first port for delivering fluid from one of a rod side or a non-rod side of the piston to an end of the internal cavity.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front view of the hydraulic actuator according to teachings of the present invention;

FIG. 2A is a cross-sectional side view of the hydraulic actuator in its retracted position showing a hydraulic feed line according to the teachings of the present invention;

FIG. 2B is a cross-sectional side view of the hydraulic actuator in its extended position showing a hydraulic feed line according to the teachings of the present invention;

FIG. 3 is a front view of the hydraulic actuator showing the swing plate in its open, or unlocked, position;

FIG. 4 is a front view of the hydraulic actuator showing the swing plate in its closed, or locked, position securing both hydraulic feed lines;

FIG. 5 is a side view of a quick connection hydraulic feed line used in conjunction with the hydraulic actuator;

FIG. 6 is a perspective view of a front end suspension of a sport utility vehicle showing the location of the hydraulic actuator according to teachings of the present invention;

FIG. 7 is a perspective view of a rear end suspension of a sport utility vehicle showing the location of the hydraulic actuator according to teachings of the present invention;

FIG. 8 is a hydraulic actuator showing banjo connections, both of the prior art;

FIG. 9A is a front view of a banjo connection of the prior art; and

FIG. 9B is a side view of a banjo connection of the prior art.

### DETAILED DESCRIPTION OF THE PREFERRED EMBODIMENTS

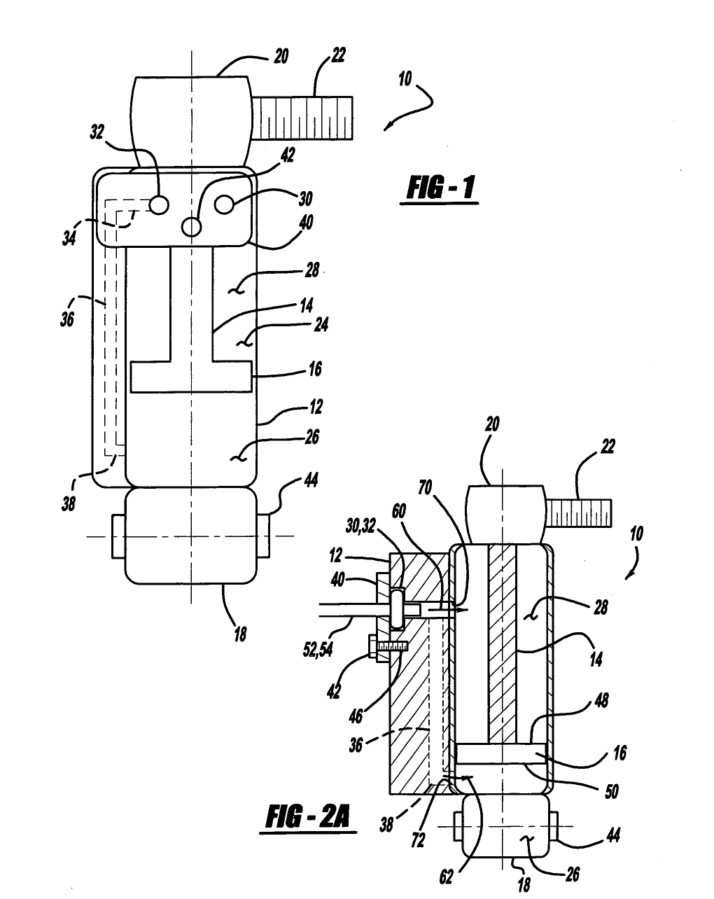

The following description of the preferred embodiments is merely exemplary in nature and is in no way intended to limit the invention, its application, or uses. FIG. 1 is a front view of the hydraulic actuator according to teachings of the present invention. Referring to FIG. 1, a hydraulic actuator 10 is generally comprised of an actuator housing 12, a fixed mounting end 18, and a moveable mounting end 20. Within the actuator housing 12 lies a rod 14, the first end of which is connected to a piston 16 while the opposite end of the rod 14 is connected to the moveable mounting end 20. Projecting from the moveable mounting end 20 is an end bolt 22. The end bolt 22 is normally connected to the end of a stabilizer bar. The fixed mounting end 18 is normally connected to a suspension component such as a wishbone in the front of the vehicle or a spring hanger if in the rear of the vehicle.

Turning to the internal workings of the hydraulic actuator 10, the hydraulic chamber 24 has a top port 30 and a bottom port 32, although the ports 30, 32 are located next to each other on the hydraulic actuator 10. The top port 30 provides access to the rod side hydraulic chamber 28, while the bottom port 32 provides access to the piston side hydraulic chamber 26, the combination of which form the hydraulic chamber 24. For hydraulic fluid to gain access to the piston side hydraulic chamber 26, the fluid enters the bottom port 32 and passes directly into the first lateral channel 34 and then into the longitudinal channel 36 and subsequently into the second lateral channel 38 before passing into the piston side, or non-rod side, hydraulic chamber 26. Shown surrounding the top port 30 and bottom port 32 is a swing plate 40 which secures the quick connections, to be discussed later, to the actuator housing 12 using a fastener 42. The fixed mounting end 18 has a bottom grommet 44 within its interior to accommodate the attachment of the fixed mounting end 18 to its suspension component.

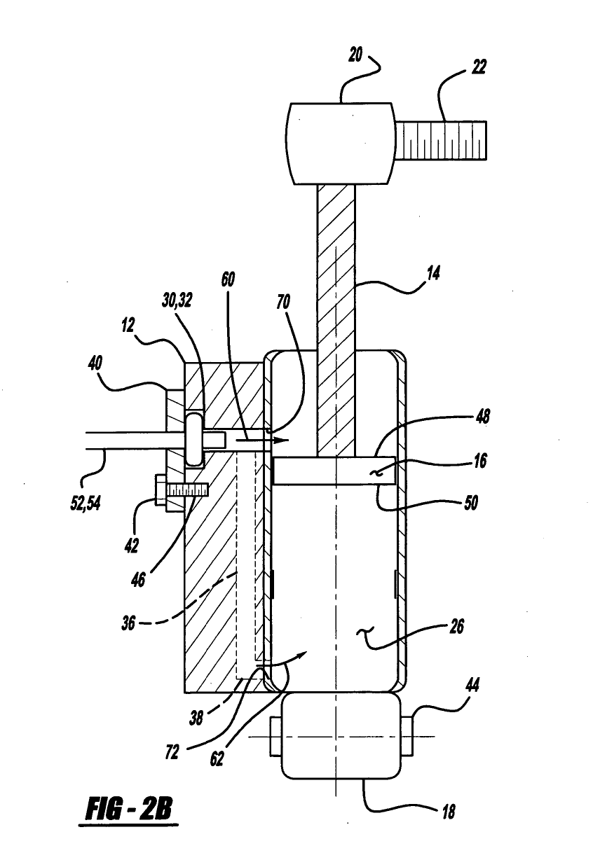

FIGS. 2A and 2B detail the interior channeling of the hydraulic actuator 10. With reference to FIGS. 1, 2A and 2B, the operative workings of the hydraulic actuator will be described. The rod 14 and piston 16 move between a top inlet 70 and a bottom inlet 72 within the actuator housing 12. The motion of the rod 14 governs the movement of the moveable mounting end 20 between its two extremes of a fully retracted position, as shown in FIG. 2A, and a fully extended position, as shown in FIG. 2B. In order for the moveable mounting end 20 to move between these two extremes, the piston 16 must move between its two extremes, the first extreme being proximate the bottom inlet 72 for the fully retracted position, and its position proximate the top inlet 70 for its fully extended position. When the piston 16 moves to extend the moveable mounting end 20 to its extended extreme, fluid flows from the inlet 72 as represented by flow arrow 62.

In order for the piston 16 to move between its two extremes, hydraulic fluid must enter the hydraulic actuator housing 12 via ports 30, 32. More specifically, hydraulic fluid must enter the rod side hydraulic chamber 28 in order to move the moveable mounting end 20 toward its retracted position, while hydraulic fluid must enter the piston side hydraulic chamber 26 in order to move the moveable mounting end 20 toward its fully extended position, as depicted in FIG. 2B. Hydraulic fluid enters the hydraulic actuator 10 through the top port 30 and bottom port 32 using a first quick connector 52 and a second quick connector 54, respectively.

An example of the quick connectors 52, 54 is shown in FIG. 5. The quick connectors 52, 54 are hollow to permit the passage of hydraulic fluid through the quick connectors 52, 54, as depicted by flow arrow 60. To interface with the hydraulic actuator housing 12, the quick connectors 52, 54 have a flange with a rolled end 56 that fits into a recession of the top port 30 and the bottom port 32. Additionally, the quick connectors 52, 54 have an O-ring 58 to ensure sealing between each of the quick connectors 52, 54 and the actuator housing 12.

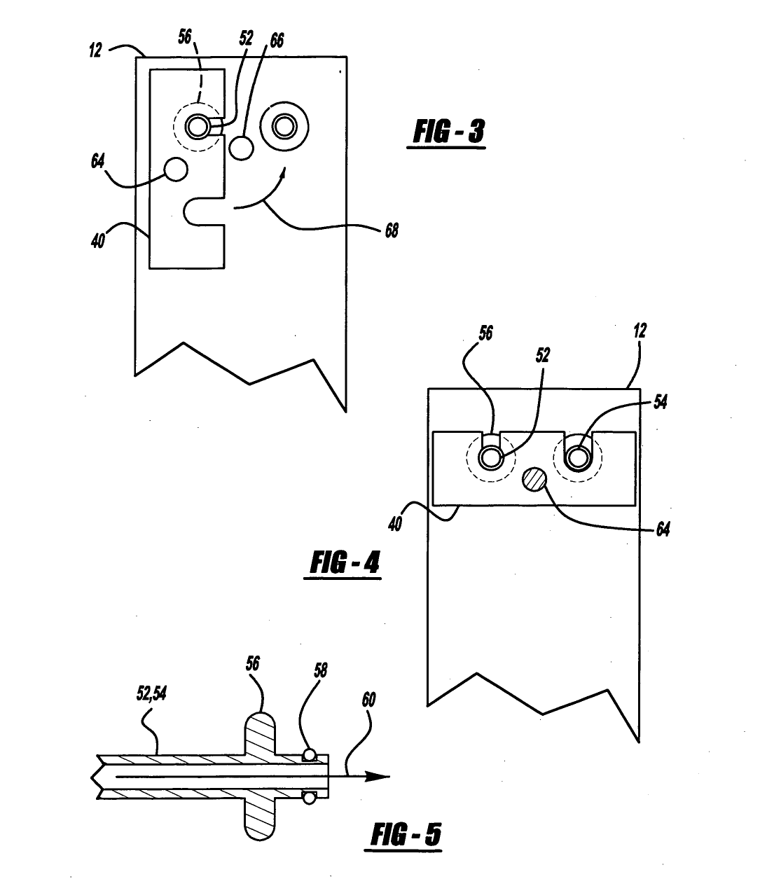

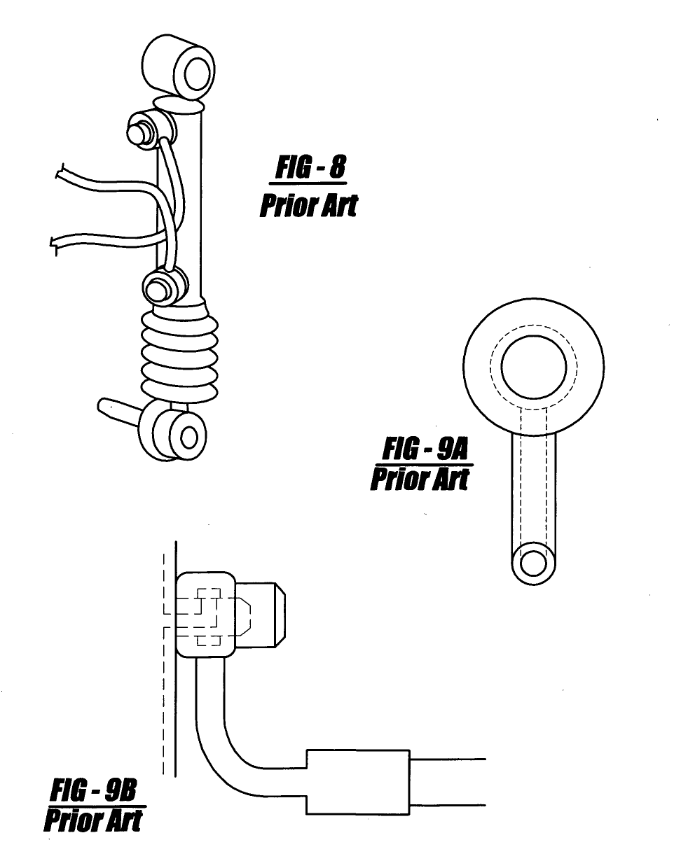

FIGS. 3 and 4 depict the operative workings of the swing plate 40. FIG. 3 depicts the swing plate 40 before it is swung into its position to be fastened to the actuator housing 12. The swing plate 40 normally is attached to one of the quick connectors 52, 54 so that upon placement of say, quick connector 52, its attached swing plate 40 can be swung in the direction of arrow 68 in order to secure both quick connectors 52, 54 against the actuator housing 12 within their respective ports. After the swing plate 40 depicted in FIG. 3 is swung into its securing position depicted in FIG. 4, a fastener 42 (FIG. 2A) is placed through the swing plate hole 64 and screwed into the housing hole 66, since the fastener 42 will normally have external threads while the housing hole 66 will normally have internal threads. When the swing plate 40 is in its screwed down and fastened position, the quick connectors 52, 54 are securely in place because the swing plate 40 thoroughly covers the flange of each quick connector 52, 54. This quick connection method utilizing quick connectors 52, 54, swing plate 40 and fastener 42 results in a much faster connection time than traditional banjo connections, as shown in FIGS. 8, 9A and 9B of the prior art. Additionally, a reduction in cost is attained because significantly fewer number of parts are utilized.

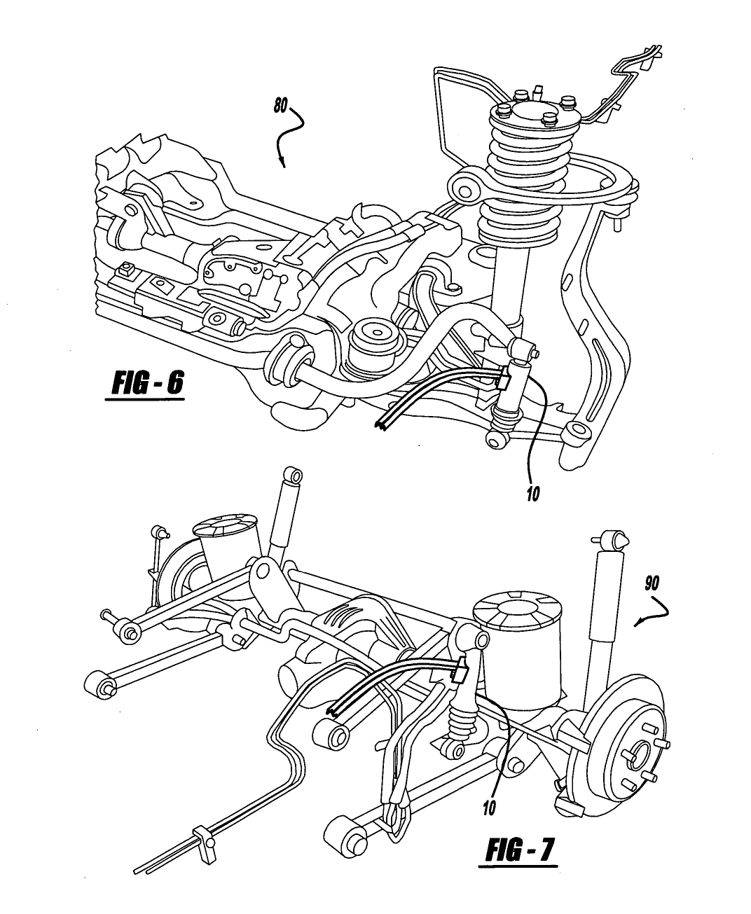

FIG. 6 is a perspective view of a front end suspension 80 commonly employed in a sport utility vehicle, pickup truck or similar vehicle. FIG. 6 depicts the hydraulic actuator 10 with a first end connected to a suspension component and a second end connected to a front sway bar. FIG. 7 is a perspective view of a rear end suspension of a sport utility vehicle, pickup truck or similar vehicle depicting the location of the hydraulic actuator 10 having its first and second ends connected to suspension components.

The method of connecting the quick connectors 52, 54 to the hydraulic actuator 10 is significantly simplified compared to the prior art method of connection, which employs a banjo connection. The method of employing quick connectors 52, 54 involves an assembler plugging in the first quick connector 52 and the second quick connector 54 into their respective ports, then moving the swing plate 40 into its position over the quick connectors 52, 54 and subsequently aligning the swing plate hole 64 with the housing hole 66 and securing the fastener 42 through the swing plate hole 64 and into the threads of the housing hole 66.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A hydraulic actuator having a housing defining an internal cavity within which a piston and rod are arranged to move longitudinally within the internal cavity, the hydraulic actuator further comprising:
a first port disposed in the actuator for delivering fluid from one of a rod side or a non-rod side of said piston to an opposite side of said piston to an end of said internal cavity via an internal channel parallel to said internal cavity; and
a second port disposed adjacent said first port in said actuator for delivering fluid from one of a rod side or a non-rod side of said piston to an end of said internal cavity.

2. The hydraulic actuator of claim 1, further comprising:
a first lateral channel that connects said first port and said longitudinal channel; and
a second lateral channel that connects said longitudinal channel and said internal cavity.

3. The hydraulic actuator of claim 1, further comprising:
a first quick connector that interfaces with said first port; and
a second quick connector that interfaces with said second port.

4. The hydraulic actuator of claim 3, further comprising:
a swing plate connected to said first quick connector such that said swing plate pivots about said first quick connector to secure said first quick connector and said second quick connector within the hydraulic actuator housing.

5. The hydraulic actuator of claim 3, said first quick connector further comprising a flange to fit within a recession of said port.

6. The hydraulic actuator of claim 1, wherein said second lateral channel directs hydraulic fluid to a non-rod side of the piston.

7. A hydraulic actuator comprising:
a housing defining an interior chamber;
a piston connected to a rod, said piston and rod traversing within said interior chamber according to hydraulic pressure on each side of said piston; and
a first port in said housing, wherein said port interfaces with an internal channel, said internal channel leading from a rod side of said piston to a non-rod side of said piston; and
a second port in said housing, wherein said second port is located adjacent to said first port, and said second port leads directly into said interior chamber, wherein said first and second ports are located proximate a first end of said housing.

8. The hydraulic actuator of claim 7, further comprising:
a first and a second quick connection line, each of said quick connection lines having a flange with a rolled periphery, said flanged portion being press-fit beneath a surface of said housing.

9. The hydraulic actuator of claim 8, further comprising:
a cover plate, said cover plate located over said flanges of said first and said second quick connection lines.

10. The hydraulic actuator of claim 9, wherein said cover plate is secured with a fastener that passes through said cover plate and into said housing.

11. The hydraulic actuator of claim 10, wherein said cover plate is attached to and is pivotable about one of the quick connection lines.

12. In a hydraulic actuator having a housing defining an internal cavity within which a piston and rod traverse to an extent such that the rod passes through an end of the actuator to cause the actuator to extend and retract, an apparatus for causing such extension and contraction comprising:
a first port at a first end of the actuator to provide fluid access to a rod side of the piston, within the internal cavity, forcing said actuator to retract; and
a second port provided at the first end of the actuator to provide fluid access to a non-rod side of the piston, within the internal cavity, forcing said actuator to extend.

13. The hydraulic actuator of claim 12, wherein said hydraulic actuator further comprises:
a longitudinal channel connecting a first and a second lateral channel, wherein said first lateral channel delivers fluid to said longitudinal channel and said second lateral channel has an inlet adjacent the internal cavity to deliver fluid to said internal cavity.

14. The hydraulic actuator of claim 13, further comprising:
a first and a second quick connector, said quick connectors each having a flange that inserts into said first and second ports, respectively.

15. The hydraulic actuator of claim 14, further comprising:
a swing plate that pivots about one of the quick connectors and over the flange of each quick connector to secure each of said quick connectors within its respective port.

16. The hydraulic actuator of claim 15, wherein each flange of each quick connector has a rounded periphery.
